(19) United States
(12) Patent Application Publication
(10) Pub. No.: US 2018/0018443 A1
(43) Pub. Date: Jan. 18, 2018

(54) METHOD AND APPARATUS FOR PROVIDING HEALTH INFORMATION

(71) Applicant: Samsung Electronics Co., Ltd., Gyeonggi-do (KR)

(72) Inventors: Seongho CHO, Seoul (KR); Byunghoon Seo, Gyeonggi-do (KR); Haebahrem Ahram Suh, Gyeonggi-do (KR)

(21) Appl. No.: 15/648,034

(22) Filed: Jul. 12, 2017

(30) Foreign Application Priority Data
Jul. 12, 2016 (KR) 10-2016-0088211

(51) Int. Cl. G06F 19/00; G01G 19/414; G09B 19/00

(52) U.S. Cl. CPC G06F 19/3475; G09B 19/0092; G01G 19/4146; G06F 19/3412; G06F 19/3481

(57) ABSTRACT

An electronic device is provided which includes a display, a camera module, an audio module, a sensor module, a radio communication unit, a processor which is electrically connected to the display, the camera module, the audio module, the sensor module, and the radio communication unit, and a memory which is electrically connected to the processor, the memory stores instructions, which when executed by the processor, display at least one electronic questionnaire selected automatically or in response to a user input, analyze at least one health-related information input by a user through the display or acquired by at least one of the camera module, the audio module, the sensor module, and the radio communication unit, reflect the health-related information analysis result in the at least one selected electronic questionnaire, and display on the display the at least one electronic questionnaire in which the at least one health-related information is reflected.

### PRIORITY

This application claims priority under 35 U.S.C. §119(a) to Korean Patent Application Serial No. 10-2016-0088211, which was filed on Jul. 12, 2016, in the Korean Intellectual Property Office, the entire disclosure of which is incorporated herein by reference.

### BACKGROUND

### 1. Field of the Disclosure

The present disclosure generally relates to an electronic device, and more particularly, to a method and apparatus for providing health information acquired by analyzing data collected through electronic questionnaires provided by means of an electronic device.

### 2. Description of the Related Art

With the growing use of electronic devices, particularly portable terminals, health care applications are becoming an essential part of electronic devices for offering their users health information.

Typically, many health care applications are designed to receive consumed food data and health condition data input by the user and provide the user with information on the calorie intake calculated based on the consumed food data, along with an average calorie intake and recommended daily intake, and give the user healthy eating habit advice based on the health condition information.

An electronic device may be designed to collect a user's health-related data. For example, the electronic device may measure, autonomously or through receipt of data input manually by the user, the health-related data such as number of steps walked, heart rate, and foods consumed by the user.

Typically, during a medical examination provided at a hospital, a doctor trusts a patient's memory alone when collecting consumed food data from a patient. The drawbacks from this data collection method are that a health condition may be incorrectly diagnosed because of the potential for data to be missing and also gathering the consumed food data through a questionnaire takes much time.

A drawback of conventional health care applications is that the consumed food data collected by an electronic device is not reflected dynamically in an electronic questionnaire.

### SUMMARY

According to an aspect of the present disclosure, a health information provision method and apparatus are provided which are capable of reflecting at least one of health-related information items (e.g., consumed food information, number of steps walked, and heart rate) input by a user through a display and/or an input unit and collected automatically in a questionnaire by at least one of a camera module, an audio module, a sensor module, and a radio communication unit.

In accordance with an aspect of the present disclosure, an electronic device is provided which includes a display, a camera module, an audio module, a sensor module, a radio communication unit, a processor which is electrically connected to the display, the camera module, the audio module, the sensor module, and the radio communication unit, and a memory which is electrically connected to the processor, the memory stores instructions, which when executed by the processor, displaying on the display at least one electronic questionnaire selected automatically or in response to a user input, analyze at least one health-related information input by a user through the display or acquired by at least one of the camera module, the audio module, the sensor module, and the radio communication unit, reflect the health-related information analysis result in the at least one selected electronic questionnaire, and display on the display the at least one electronic questionnaire in which the at least one health-related information is reflected.

In accordance with another aspect of the present disclosure, a health information provision method of an electronic device is provided which includes displaying on the display at least one electronic questionnaire selected automatically or in response to a user input, analyzing at least one health-related information input by a user through a display or acquired by at least one of a camera module, an audio module, a sensor module, and a radio communication unit, reflecting the health-related information analysis result in the selected electronic questionnaire, and displaying on the display the at least one electronic questionnaire in which the at least one health-related information is reflected.

In accordance with another aspect of the present disclosure, a computer-readable storage medium storing a program for controlling functions of an electronic device is provided which includes instructions which when executed by a processor, displays at least one electronic questionnaire selected automatically or in response to a user input, analyzes at least one health-related information input by a user through the display or acquired by at least one of a camera module, an audio module, a sensor module, and a radio communication unit, reflects the health-related information analysis result in the at least one selected electronic questionnaire, and displays on the display the at least one electronic questionnaire in which the at least one health-related information is reflected.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram illustrating an electronic device in a network environment, according to an embodiment of the present disclosure;

FIG. 2 is a block diagram illustrating a configuration of an electronic device, according to an embodiment of the present disclosure;

FIG. 3 is a block diagram illustrating a configuration of a program module, according to an embodiment of the present disclosure;

FIG. 4 is a block diagram illustrating a configuration of a health care information provision system, according to an embodiment of the present disclosure;

FIG. 5 illustrates screenshots of consumed food information pages, according to an embodiment of the present disclosure;

FIG. 6 is a diagram illustrating an electronic questionnaire, according to an embodiment of the present disclosure;

FIG. 7 is a block diagram illustrating a configuration of a processor, according to an embodiment of the present disclosure;

FIG. 8 is a flowchart illustrating a health information provision method, according to an embodiment of the present disclosure;

FIG. 9 is a flowchart illustrating a health care service provision method, according to an embodiment of the present disclosure;

FIG. 10 is a table summarizing answers to questions of an electronic questionnaire, according to an embodiment of the present disclosure; and

FIG. 11 is a diagram illustrating a questionnaire report generated based on the answers to the questions of the electronic questionnaire, according to an embodiment of the present disclosure.

### DETAILED DESCRIPTION

The following description with reference to the accompanying drawings is provided to assist in a comprehensive understanding of certain embodiments of the present disclosure as defined by the claims and their equivalents. It includes various specific details to assist in that understanding but these are to be regarded as merely exemples. Accordingly, various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to their dictionary meanings, but are used to enable an understanding of the present disclosure. Accordingly, the following description of various embodiments of the present disclosure is provided for illustration purposes only and do not limit the present disclosure as defined by the appended claims and their equivalents.

It is to be understood that the singular forms “a,” “an,” and “the” include plural forms unless the context clearly indicates otherwise. Thus, for example, reference to “a component surface” includes reference to one or more of such surfaces.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated. For example, “A or B,” “at least one of A and B,” or “at least one of A or B” means (1) including at least one A, (2) including at least one B, or (3) including both at least one A and at least one B.

Terms such as “first” and “second” as used herein may modify various elements regardless of an order and/or importance of the corresponding elements, but do not limit the corresponding elements. These terms may be used for the purpose of distinguishing one element from another element. For example, a first user device and a second user device may indicate different user devices regardless of the order or importance. For example, a first element may be referred to as a second element without departing from the scope the present disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. On the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with the expressions “suitable for,” “having the capacity to,” “designed to,” “adapted to,” “made to,” or “capable of” according to a context. The term “configured to (or set to)” does not necessarily mean, “specifically designed to” in hardware. Instead, the expression “apparatus configured to . . . ” may mean that the apparatus is “capable of . . . ” along with other devices or parts in a certain context. For example, “a processor configured to (or set to) perform A, B, and C” may mean a dedicated processor (e.g., an embedded processor) for performing a corresponding operation, or a general-purpose processor (e.g., a central processing unit (CPU) or an application processor) capable of performing a corresponding operation by executing one or more software programs stored in a memory device.

The terms used in describing various embodiments of the present disclosure are for the purpose of describing particular embodiments and do not limit the present disclosure. As used herein, the singular forms are intended to include the plural forms as well, unless the context clearly indicates otherwise. All of the terms used herein including technical or scientific terms have the same meanings as those generally understood by persons of ordinary skill in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even terms defined in this disclosure should not be interpreted as excluding the embodiments of the present disclosure.

Electronic devices according to an embodiment of the present disclosure may include at least one of, for example, smart phones, tablet personal computers (PCs), mobile phones, video telephones, electronic book readers, desktop PCs, laptop PCs, netbook computers, workstations, servers, personal digital assistants (PDAs), portable multimedia players (PMPs), motion picture experts group (MPEG-1 or MPEG-2) audio layer 3 (MP3) players, mobile medical devices, cameras, or wearable devices. The wearable devices may include at least one of accessory-type wearable devices (e.g., watches, rings, bracelets, anklets, necklaces, glasses, contact lenses, or head-mounted-devices (HMDs)), fabric or clothing integral wearable devices (e.g., electronic clothes), body-mounted wearable devices (e.g., skin pads or tattoos), or implantable wearable devices (e.g., implantable circuits).

The electronic devices may be smart home appliances. The smart home appliances may include at least one of, for example, televisions (TVs), digital versatile disc (DVD) players, audio players, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ and PlayStation™), electronic dictionaries, electronic keys, camcorders, or electronic picture frames.

The electronic devices may include at least one of various medical devices (e.g., various portable medical measurement devices (such as blood glucose meters, heart rate monitors, blood pressure monitors, or thermometers, and the like), a magnetic resonance angiography (MRA) device, a magnetic resonance imaging (MRI) device, a computed tomography (CT) device, scanners, or ultrasonic devices, and the like), navigation devices, global positioning system (GPS) receivers, event data recorders (EDRs), flight data recorders (FDRs), vehicle infotainment devices, electronic equipment for vessels (e.g., navigation systems, gyrocompasses, and the like), avionics, security devices, head units for vehicles, industrial or home robots, automatic teller machines (ATMs), points of sales (POSs) terminals, or Internet of things (IoT) devices (e.g., light bulbs, various sensors, electric or gas meters, sprinkler devices, fire alarms, thermostats, street lamps, toasters, exercise equipment, hot water tanks, heaters, boilers, and the like).

The electronic devices may further include at least one of parts of furniture or buildings/structures, electronic boards, electronic signature receiving devices, projectors, or various measuring instruments (such as water meters, electricity meters, gas meters, or wave meters, and the like). The electronic devices may be one or more combinations of the above-mentioned devices. The electronic devices may be flexible electronic devices. In addition, the electronic devices are not limited to the above-mentioned devices, and may include new electronic devices according to the development of new technologies.

Hereinafter, electronic devices according to an embodiment of the present disclosure will be described with reference to the accompanying drawings. The term “user” as used herein may refer to a person who uses an electronic device or may refer to a device (e.g., an artificial intelligence electronic device) which uses an electronic device.

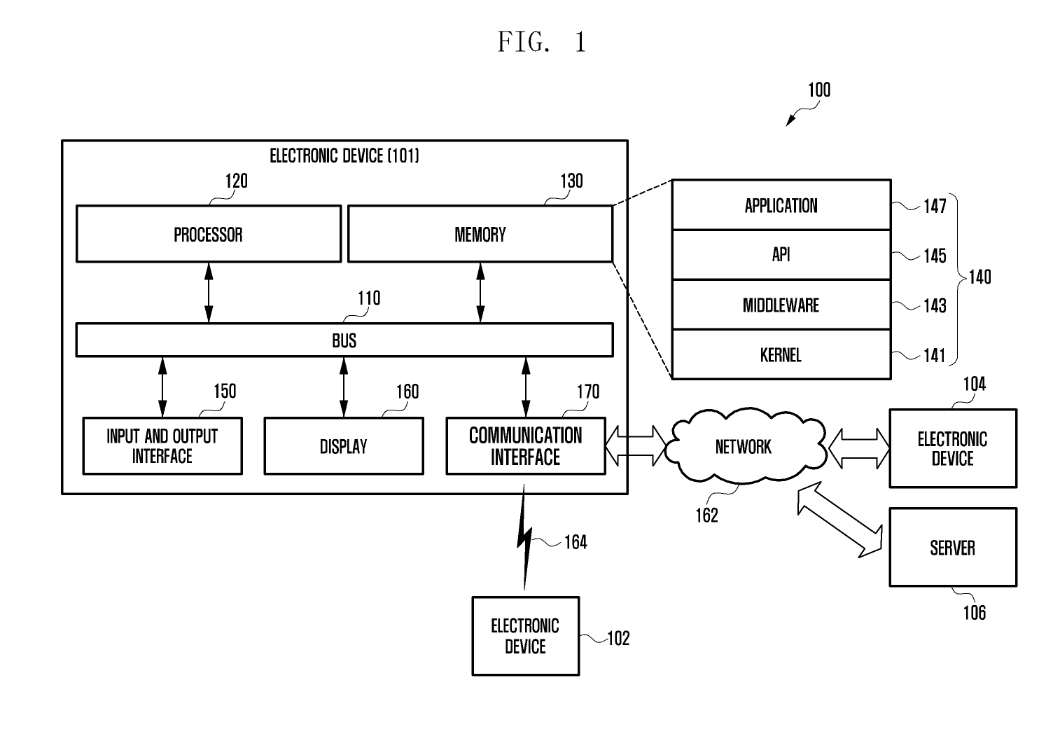

FIG. 1 illustrates an electronic device in a network environment, according to an embodiment of the present disclosure.

Referring to FIG. 1, a network environment 100 includes an electronic device 101 having a bus 110, a processor 120, a memory 130, an input/output interface 150, a display 160, and a communication interface 170. At least one of the above described components may be omitted from the electronic device 101 or another component may be further included in the electronic device 101.

The bus 110 may be a circuit connecting and transmitting communications (e.g., control messages and/or data) between the processor 120, the memory 130, the input/output interface 150, the display 160, and the communication interface 170.

The processor 120 may include one or more of a CPU, an application processor (AP), and a communication processor (CP). The processor 120 is capable of controlling at least one of other components of the electronic device 101 and/or processing data or operations related to communication.

The memory 130 may include volatile memory and/or non-volatile memory. The memory 130 is capable of storing data or commands related to at least one of other components of the electronic device 101. The memory 130 is capable of storing software and/or a program module 140. For example, the program 140 includes a kernel 141, middleware 143, an application programming interface (API) 145, and applications 147, etc. The kernel 141, the middleware 143 or at least part of the API 145 may be called an operating system (OS).

The kernel 141 is capable of controlling or managing system resources (e.g., the bus 110, the processor 120, the memory 130, etc.) used to execute operations or functions of other programs (e.g., the middleware 143, the API 145, and the applications 147). The kernel 141 provides an interface capable of allowing the middleware 143, the API 145, and the applications 147 to access and control/manage the individual components of the electronic device 101.

The middleware 143 may be an interface between the API 145 or the applications 147 and the kernel 141 so that the API 145 or the applications programs 147 may communicate with the kernel 141 and exchange data therewith. The middleware 143 is capable of processing one or more task requests received from the applications 147 according to the priority. For example, the middleware 143 is capable of assigning a priority for use of system resources of the electronic device 101 (e.g., the bus 110, the processor 120, the memory 130, etc.) to at least one of the applications 147. For example, the middleware 143 processes one or more task requests according to a priority assigned to at least one application program, thereby performing scheduling or load balancing for the task requests.

The API 145 may be an interface that is configured to allow the applications 147 to control functions provided by the kernel 141 or the middleware 143. The API 145 may include at least one interface or function (e.g., instructions) for file control, window control, image process, text control, and the like.

The input/output interface 150 is capable of transferring instructions or data, received from the user or external devices, to one or more components of the electronic device 101. The input/output interface 150 is capable of outputting instructions or data, received from one or more components of the electronic device 101, to the user or external devices.

The display 160 may include a liquid crystal display (LCD), a flexible display, a transparent display, a light emitting diode (LED) display, an organic LED (OLED) display, micro-electro-mechanical systems (MEMS) display, an electronic paper display, etc. The display 160 is capable of displaying various types of content (e.g., texts, images, videos, icons, symbols, etc.). The display 160 may also be implemented with a touch screen. In this case, the display 160 is capable of receiving touches, gestures, proximity inputs or hovering inputs, via a stylus pen, or a user's body.

The communication interface 170 is capable of establishing communication between the electronic device 101 and an external device For example, the communication interface 170 is capable of communicating with an external device connected to a network 162 via wired or wireless communication.

Wireless communication may employ, as cellular communication protocol, at least one of long-term evolution (LTE), LTE advanced (LTE-A), code division multiple access (CDMA), wideband CDMA (WCDMA), universal mobile telecommunications system (UMTS), wireless broadband (WiBro), and global system for mobile communication (GSM). Wireless communication may also include short-range communication 164. Short-range communication 164 may include at least one of wireless fidelity (Wi-Fi), Bluetooth™ (BT), near field communication (NFC), magnetic secure transmission (MST), and global navigation satellite system (GNSS). The GNSS may include at least one of GPS, global navigation satellite system (Glonass), Beidou navigation satellite system (Beidou), and Galileo, the European global satellite-based navigation system, according to GNSS use areas, bandwidths, etc. In the present disclosure, the terms “GPS” and “GNSS” may be used interchangeably. Wired communication may include at least one of universal serial bus (USB), high definition multimedia interface (HDMI), recommended standard 232 (RS-232), and plain old telephone service (POTS). The network 162 may include at least one of a telecommunications network, e.g., a computer network (e.g., local area network (LAN) or a wide area network (WAN)), the Internet, and a telephone network.

A first external electronic device 102 and a second external electronic device 104 may be each identical to or different from the electronic device 101, in terms of type. According to an embodiment of the present disclosure, a server 106 includes a group of one or more servers. Part or all of the operations executed on the electronic device 101 may be executed on another electronic device or electronic device 102 and 104 or a server 106. When the electronic device needs to perform a function or service automatically or according to a request, it may not perform the function or service, but is capable of additionally requesting at least part of the function related to the function or service from another electronic devices 102 and 104 or a server 106. The electronic devices 102 and 104 or a server 106 are capable of executing the requested function or additional functions, and transmitting the result to the electronic device 101. The electronic device 101 processes the received result, or further proceeds with additional processes, to provide the requested function or service. To this end, the electronic device 101 may employ cloud computing, distributed computing, or client-server computing technology.

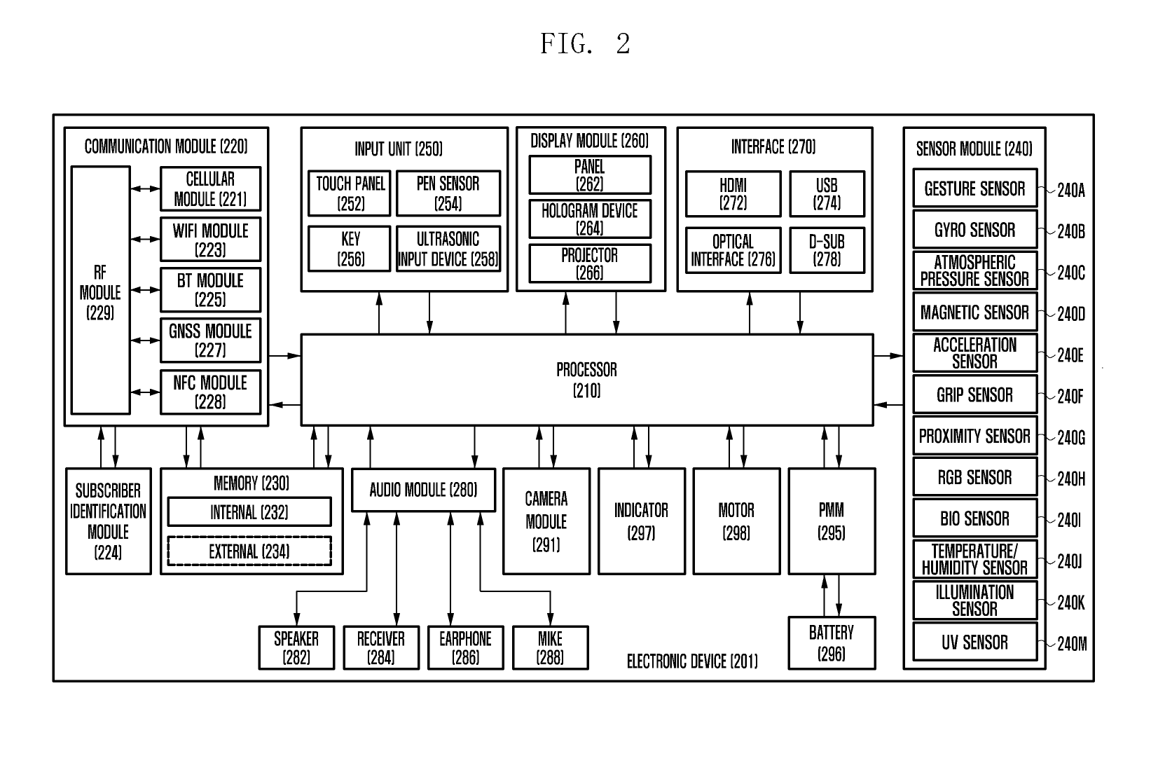

FIG. 2 is a block diagram of a configuration of an electronic device, according to an embodiment of the present disclosure.

Referring to FIG. 2, an electronic device 201 may include a part or all of the components in the electronic device 101 shown in FIG. 1. The electronic device 201 includes one or more processors 210 (e.g., APs), a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 is capable of driving, for example, an operating system or an application program to control a plurality of hardware or software components connected to the processor 210, processing various data, and performing operations. The processor 210 may be implemented as, for example, a system on chip (SoC). The processor 210 may further include a graphic processing unit (GPU) and/or an image signal processor. The processor 210 may also include at least part of the components shown in FIG. 2, e.g., a cellular module 221. The processor 210 is capable of loading commands or data received from at least one other component (e.g., a non-volatile memory) or a volatile memory and processing the loaded commands or data. The processor 210 is capable of storing various data in a non-volatile memory.

The communication module 220 may include the same or similar configurations as the communication interface 170 shown in FIG. 1. For example, the communication module 220 includes the cellular module 221, a Wi-Fi module 223, a BT module 225, a GNSS module 227 (e.g., a GPS module, Glonass module, Beidou module or Galileo module), an NFC module 228, and a radio frequency (RF) module 229.

The cellular module 221 is capable of providing a voice call, a video call, an SMS service, an Internet service, etc., through a communication network, for example. The cellular module 221 is capable of identifying and authenticating an electronic device 201 in a communication network by using the SIM 224. The cellular module 221 is capable of performing at least a part of the functions provided by the processor 210. The cellular module 221 may include a CP.

Each of the Wi-Fi module 223, the BT module 225, the GNSS module 227, and the NFC module 228 may include a processor for processing data transmitted or received through the corresponding module. At least part of the cellular module 221, Wi-Fi module 223, BT module 225, GNSS module 227, and NFC module 228 (e.g., two or more modules) may be included in one integrated chip (IC) or one IC package.

The RF module 229 is capable of transmission/reception of communication signals, e.g., RF signals. The RF module 229 includes a transceiver, a power amplifier module (PAM), a frequency filter, a low noise amplifier (LNA), an antenna, etc. At least one of the cellular module 221, the Wi-Fi module 223, the BT module 225, the GNSS module 227, and the NFC module 228 is capable of transmission/reception of RF signals through a separate RF module.

The memory 230 includes a built-in memory 232 or an external memory 234. The built-in memory 232 includes at least one of a volatile memory, e.g., a dynamic random access memory (DRAM), a static RAM (SRAM), a synchronous dynamic RAM (SDRAM), etc. and a non-volatile memory, e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, an NOR flash memory, etc.), a hard drive, a solid state drive (SSD), etc.

The external memory 234 may include a flash drive, e.g., a compact flash (CF), a secure digital (SD), a micro secure digital (micro-SD), a mini secure digital (mini-SD), an extreme digital (xD), a multi-media card (MMC), a memory stick, etc. The external memory 234 may be connected to the electronic device 201, functionally and/or physically, through various interfaces.

The sensor module 240 is capable of measuring/detecting a physical quantity or an operation state of the electronic device 201, and converting the measured or detected information into an electronic signal. The sensor module 240 may include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green and blue (RGB) sensor), a biometric sensor 240I, a temperature/humidity sensor 240J, an illuminance sensor 240K, and a ultraviolet (UV) sensor 240M. Additionally or alternatively, the sensor module 240 may also include an e-nose sensor, an electromyography (EMG) sensor, an electroencephalogram (EEG) sensor, an electrocardiogram (ECG) sensor, an infrared (IR) sensor, an iris sensor and/or a fingerprint sensor. The sensor module 240 may further include a control circuit for controlling one or more sensors included therein. The electronic device 201 may include a processor, configured as part of the processor 210 or a separate component, for controlling the sensor module 240. In this case, while the processor 210 is operating in sleep mode, the processor is capable of controlling the sensor module 240.

The input device 250 includes a touch panel 252, a (digital) pen sensor 254, a key 256, or an ultrasonic input unit 258. The touch panel 252 may be implemented with at least one of a capacitive touch system, a resistive touch system, an infrared touch system, and an ultrasonic touch system. The touch panel 252 may further include a control circuit, and the touch panel 252 may include a tactile layer to provide a tactile response to the user. The (digital) pen sensor 254 may be implemented with a part of the touch panel or with a separate recognition sheet. The key 256 may include a physical button, an optical key, or a keypad. The ultrasonic input unit 258 is capable of detecting ultrasonic waves, through a microphone 288, and identifying data corresponding to the detected ultrasonic waves.

The display 260 includes a panel 262, a hologram unit 264, or a projector 266. The panel 262 may include the same or similar components as the display 160 shown in FIG. 1. The panel 262 may be flexible, transparent, or wearable. The panel 262 may also be incorporated into one module together with the touch panel 252. The hologram unit 264 is capable of showing a stereoscopic image in the air by using light interference. The projector 266 is capable of displaying an image by projecting light onto a screen. The screen may be located inside or outside of the electronic device 201. The display 260 may further include a control circuit for controlling the panel 262, the hologram unit 264, or the projector 266.

The interface 270 includes an HDMI 272, a USB 274, an optical interface 276, or a d-subminiature (D-sub) 278.

The interface 270 may be included in the communication interface 170 shown in FIG. 1. Additionally or alternatively, the interface 270 may include a mobile high-definition link (MHL) interface, a SD card/MMC interface, or an infrared data association (IrDA) standard interface.

The audio module 280 is capable of providing bidirectional conversion between a sound and an electronic signal. At least part of the components in the audio module 280 may be included in the input/output interface 150 shown in FIG. 1. The audio module 280 is capable of processing sound information input or output through a speaker 282, a receiver 284, earphones 286, microphone 288, etc.

The camera module 291 is a device capable of capturing both still and moving images. The camera module 291 may include one or more image sensors (e.g., a front image sensor or a rear image sensor), a lens, an image signal processor (ISP), a flash (e.g., an LED or xenon lamp), etc.

The power management module 295 is capable of managing power of the electronic device 201. The power management module 295 may include a power management integrated circuit (PMIC), a charger IC, or a battery gauge. The PMIC may employ wired charging and/or wireless charging methods. Examples of the wireless charging method are magnetic resonance charging, magnetic induction charging, and electromagnetic charging. The PMIC may further include an additional circuit for wireless charging, such as a coil loop, a resonance circuit, a rectifier, etc. The battery gauge is capable of measuring the residual charge capacity, voltage, current, or temperature of the battery 296. The battery 296 may take the form of either a rechargeable battery or a solar battery.

The indicator 297 is capable of displaying a specific status of the electronic device 201 or a part thereof (e.g., the processor 210), e.g., a boot-up status, a message status, a charging status, etc. The motor 298 is capable of converting an electrical signal into mechanical vibrations, such as, a vibration effect, a haptic effect, etc. The electronic device 201 may also include a processing unit (e.g., GPU) for supporting a mobile TV. The processing unit for supporting a mobile TV is capable of processing media data pursuant to standards, e.g., digital multimedia broadcasting (DMB), digital video broadcasting (DVB), or MediaFlo™, etc.

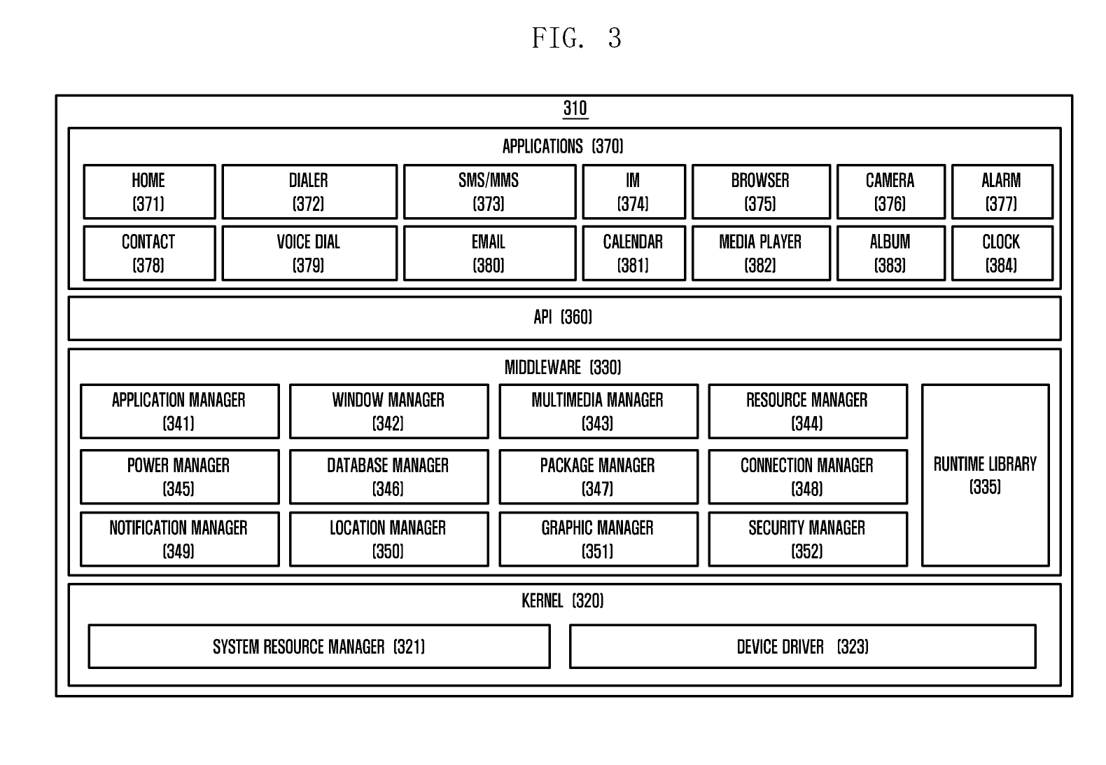

FIG. 3 is a block diagram of a programming module according to an embodiment of the present disclosure.

Referring to FIG. 3, a program module 310 (e.g., program module 140 shown in FIG. 1) includes an OS for controlling resources related to the electronic device 101 and/or various applications 147 running on the OS. The OS may be Android™, iOS™, Windows™, Symbian™, Tizen™, Bada™, etc.

The program module 310 includes a kernel 320, middleware 330, an API 360 and/or applications 370. At least part of the program module 310 may be preloaded on the electronic device or downloaded from electronic device 102, 104, or server 106.

The kernel 320 (for example, kernel 141) includes a system resource manager 321 and/or a device driver 323. The system resource manager 321 may include, for example, a process manager, a memory manager, and a file system manager. The system resource manager 321 may perform a system resource control, allocation, and recall. The device driver 323 may include, for example, a display driver, a camera driver, a Bluetooth™ driver, a shared memory driver, a USB driver, a keypad driver, a Wi-Fi driver, and an audio driver. The device driver 323 may include an inter-process communication (IPC) driver.

The middleware 330 may provide a function required in common by the applications 370. Further, the middleware 330 may provide a function through the API 360 to allow the applications 370 to efficiently use limited system resources within the electronic device. According to an embodiment of the present disclosure, the middleware 330 includes at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, and a security manager 352. The middleware 330 may also include a payment manager.

The runtime library 335 may include, for example, a library module used by a complier to add a new function through a programming language while the applications 370 are executed. According to an embodiment of the present disclosure, the runtime library 335 executes input and output, management of a memory, a function associated with an arithmetic function and the like.

The application manager 341 may manage, for example, a life cycle of at least one of the applications 370. The window manager 342 may manage GUI resources used on the screen. The multimedia manager 343 may detect a format required for reproducing various media files and perform an encoding or a decoding of a media file by using a codec suitable for the corresponding format. The resource manager 344 manages resources such as source code, a memory, or a storage space of at least one of the applications 370.

The power manager 345 may operate together with a basic input/output system (BIOS) to manage a battery or power and provides power information. The database manager 346 may manage generation, searching, and changing of a database to be used by at least one of the applications 370. The package manager 347 may manage an installation or an update of an application distributed in a form of a package file.

The connection manager 348 may manage, for example, a wireless connection such as Wi-Fi or Bluetooth™. The notification manager 349 may display or notify a user of an event such as an arrival message, an appointment, a proximity alarm and the like, in a manner that does not disturb the user. The location manager 350 may manage location information of the electronic device. The graphic manager 351 may manage a graphic effect provided to the user or a user interface related to the graphic effect. The security manager 352 provides a general security function required for a system security or a user authentication. According to an embodiment of the present disclosure, when the electronic device 101 has a call function, the middleware 330 may further include a telephony manager for managing a voice of the electronic device or a video call function.

The middleware 330 includes modules for configuring various combinations of functions of the above described components. The middleware 330 is capable of providing modules specialized according to types of operating systems to provide distinct functions. The middleware 330 may be adaptively configured in such a way as to remove part of the existing components or to include new components.

The API 360 may be a set of API programming functions, and may be provided with a different configuration according to an operating system. For example, in Android™ or iOS™, a single API set may be provided for each platform. In Tizen™, two or more API sets may be provided.

The applications 370 may include one or more applications for performing various functions, e.g., home 371, dialer 372, short message service (SMS)/multi-media message service (MMS) 373, instant message (IM) 374, browser 375, camera 376, alarm 377, contact 378, voice dial 379, email 380, calendar 381, media player 382, album 383, and clock 384. The applications 370 may also include health care (e.g., an application for measuring an amount of exercise, blood sugar level, etc.), and environment information (e.g., an application for providing atmospheric pressure, humidity, temperature, etc.).

According to an embodiment of the present disclosure, the applications 370 include an information exchange application for supporting information exchange between an electronic device 101 and electronic devices 102 and 104. The information exchange application includes a notification relay application for relaying specific information to external devices or a device management application for managing external devices.

According to an embodiment of the present disclosure, the applications 370 may include an application (e.g., a health care application of a mobile medical device, etc.) having specified attributes of electronic devices 102 and 104. The applications 370 may include applications received from a server 106 or electronic devices 102 and 104. The applications 370 may include a preloaded application or third party applications that may be downloaded from a server. It should be understood that the components of the program module 310 may be called different names according to the type of operating systems.

The term “module” according to an embodiment of the disclosure, means, but is not limited to, a unit of one of software, hardware, and firmware or any combination thereof. The term “module” may be used interchangeably with the terms “unit,” “logic,” “logical block,” “component,” or “circuit.” The “module” may denote a smallest unit of component or a part thereof. The “module” may be the smallest unit of performing at least one function or a part thereof. A module may be implemented mechanically or electronically. For example, a module may include at least one of application-specific integrated circuit (ASIC) chip, field-programmable gate arrays (FPGAs), and programmable-logic device known or to be developed.

According to an embodiment of the present disclosure, the devices (e.g. modules or their functions) or methods may be implemented by computer program instructions stored in a computer-readable storage medium. In the case that the instructions are executed by at least one processor 120, the at least one processor 120 may execute the functions corresponding to the instructions. The computer-readable storage medium may be the memory 130. At least a part of the programming module may be implemented (e.g. executed) by the processor 120. At least a part of the programming module may include modules, programs, routines, sets of instructions, and processes for executing the at least one function.

The computer-readable storage medium includes magnetic media such as a floppy disk and a magnetic tape, optical media including a compact disc (CD) ROM and a DVD ROM, a magneto-optical media such as a floptical disk, and the hardware device designed for storing and executing program commands such as ROM, RAM, and flash memory. The program commands include the high level code executable by computers using the interpreter as well as the machine language codes created by a compiler. The aforementioned hardware device may be implemented with one or more software modules for executing the operations of an embodiment of the present disclosure.

The module or programming module of the present disclosure may include at least one of the aforementioned components with omission of some components or addition of other components. The operations of the modules, programming modules, or other components may be executed in series, in parallel, recursively, or heuristically. Some operations may be executed in different order, omitted, or extended with other operations.

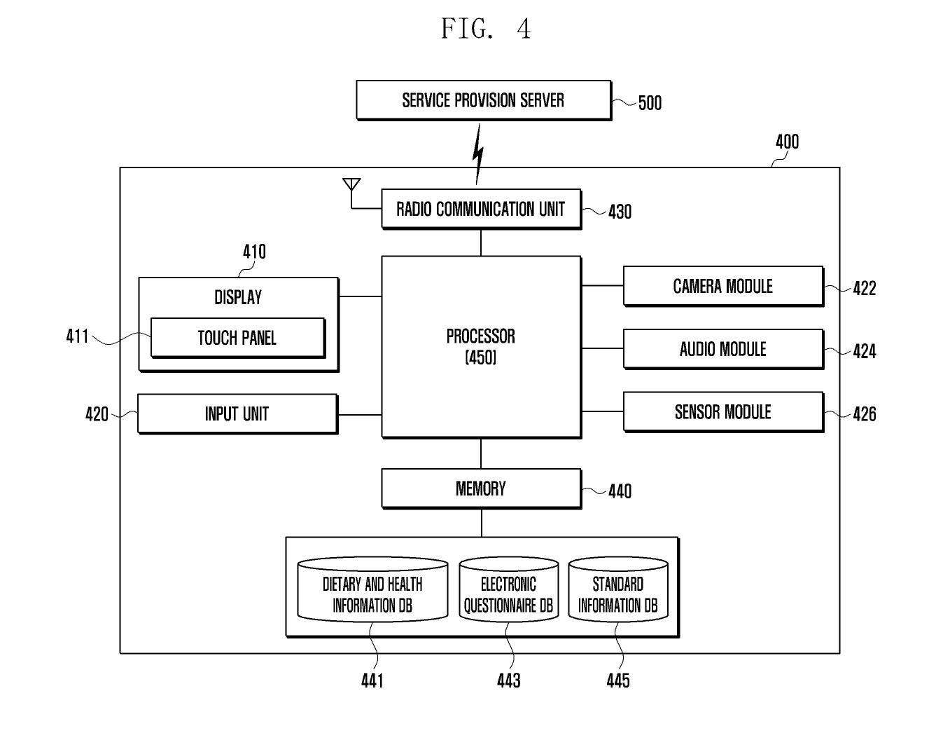

FIG. 4 is a block diagram illustrating a configuration of a health care information provision system, according to an embodiment of the present disclosure.

As shown in FIG. 4, the health information provision system of the present disclosure includes an electronic device 400 and a service provision server 500.

According to an embodiment of the present disclosure, the electronic device 400 may include part or the entire configuration of at least one of the electronic devices 101, 102, and 104 of FIG. 1 and the electronic device 201 of FIG. 2. Examples of the electronic device 400 may include a smartphone, a tablet PC, and a wearable device.

According to an embodiment of the present disclosure, the electronic device 400 includes a display 410, an input unit 420, a camera module 422, an audio module 424, a sensor module 426, a radio communication unit 430, a memory 440, and a processor 450.

According to an embodiment of the present disclosure, the display 410 may have an input function and a display function. For this purpose, the display 410 includes a touch panel 411. The touch panel 411 may be a capacitive overlay type touch panel, a resistive overlay type touch panel, an infrared beam type touch panel, or a pressure sensor type touch panel. The touch panel 411 may also be implemented with other types of sensors capable of detecting any contact or pressure made by an object. The touch panel 411 may detect a touch input made by a user, generate a detection signal and transmit the detection signal to the processor 450. The detection signal may include coordinates of a touch. If the touch position is changed by a drag gesture of the user, the touch panel 411 may generate the detection information including the coordinates on the path of the drag gesture and transmit the detection information to the processor 450.

According to an embodiment of the present disclosure, the display 410 may be equivalent to the display 160 of FIG. 1 or the display 260 of FIG. 2. The display 410 may include a touchscreen capable of receiving at least one of a touch input, a gesture input, a proximity input, and a hovering input made by means of an electronic pen or a part of the user's body. The display 410 includes the panel 262, the hologram device 264, the projector 266, as shown in FIG. 2, and/or a control circuit for controlling them. The panel 262 may be implemented to be flexible, transparent, and/or wearable. The panel 262 includes a touch panel 252 and one or more function modules. The panel 262 may include a pressure sensor (or force sensor) capable of measuring the pressure of a user's touch. The pressure sensor may be integrated into the touch panel 252 or implemented as a module along with one or more sensors, separated from the touch panel 252. The hologram device 264 may project a 3-dimensional (3D) image in the air using light interference.

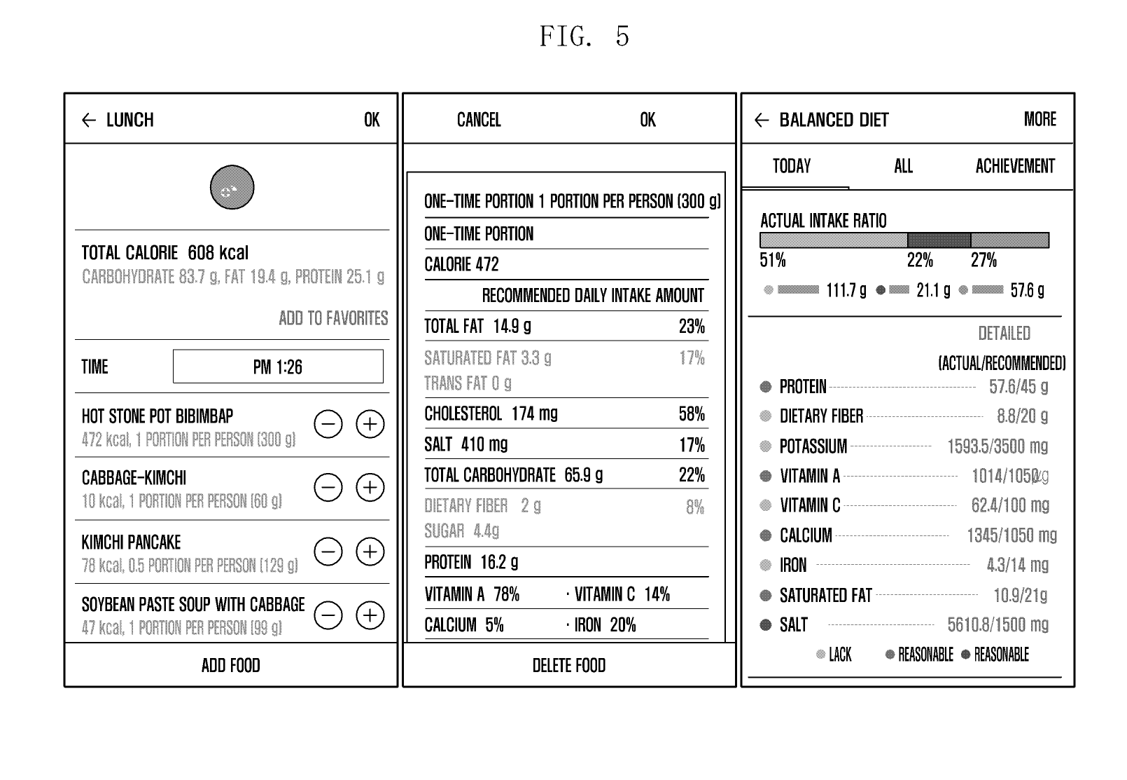

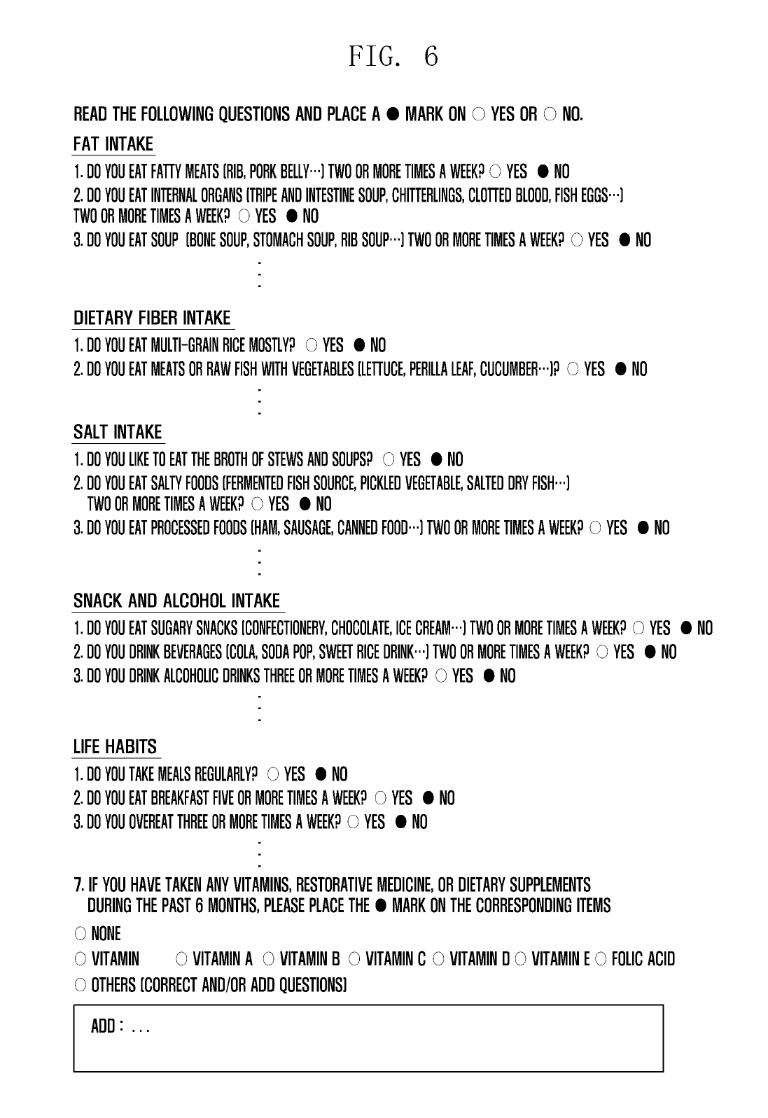

According to an embodiment of the present disclosure, the display 410 may display at least one electronic questionnaire selected automatically or in response to a user input made for selecting the corresponding questionnaire. The touch panel 411 may display a screen page prompting the user to input consumed foods as shown in FIG. 5 or an electronic questionnaire with questions and possible answers as shown in FIG. 6.

FIG. 5 illustrates screen shots of consumed food information pages, according to an embodiment of the present disclosure.

FIG. 6 is a diagram illustrating an electronic questionnaire, according to an embodiment of the present disclosure.

In reference to FIG. 5, a consumed food information page may be configured to receive the user input on the foods consumed per meal and display total calories estimated based on the consumed foods.

In reference to FIG. 6, the electronic questionnaire may include several sections for fat intake, dietary fiber intake, salt intake, snack intake, alcohol intake, life habits, and other question. Other sections are provided to correct questions or add new questions.

Although the embodiment of FIG. 6 exemplifies an electronic questionnaire including the items of foods consumed by the user, the electronic questionnaire may be configured receive health-related data such as walking and running, stress level, blood pressure level, weight, sleep amount, heart rate, and blood sugar level and to allow for the user to modify the items and add new items by means of an electronic pen.

According to an embodiment of the present disclosure, the display 410 may display various menu items to the user and input information by the user. The display 410 may be implemented with a liquid crystal display panel, an organic light emitting diodes (OLED) panel, an active matrix OLED (AMOLED) panel, a flexible display panel, or a transparent display panel. The display 410 may display various screens generated during the operation of the electronic device 400. Examples of the screens include a home screen, a menu screen, a lock screen, a game execution screen, a webpage screen, a call screen, and an audio and video playback screen

According to an embodiment of the present disclosure, the display 410 may display health-related information, consumed foods analysis information, content of a questionnaire, and consumed foods and health analysis results under the control of the processor 450.

According to an embodiment of the present disclosure, the input unit 420 (e.g., input device 250 of FIG. 2) may generate various types of input signals necessary for the operation of the electronic device 400. The input unit 420 may receive a user input for user settings under control of the electronic device 400, generate a corresponding input signal and transmit it to the processor 450. The input unit 420 may include a plurality of alphanumeric keys for receiving alphanumeric information and function keys for configuring and executing various functions. The input unit 410 may be implemented with one or any combination of a QWERTY keypad, a 3×4 keypad, a 4×3 keypad, a ball joystick, an optical joystick, a wheel key, a touch key, a touchpad, and the aforementioned touch panel 411.

According to an embodiment of the present disclosure, the input unit 420 may be used to select answers to the questions of the electronic questionnaire displayed on the display 410 or write a request for correcting the questions and adding new questions in the window provided at the bottom of the electronic questionnaire as shown in FIG. 6.

According to an embodiment of the present disclosure, the camera module 422 is a device for capturing a still or a motion image and may include at least one image sensor (e.g., front sensor and/or rear sensor), a lens, an image signal processor (ISP), and a flash (e.g., LED lamp and xenon lamp).

According to an embodiment of the present disclosure, the electronic device 400 may acquire at least one image including those of foods by means of the camera module 422. The electronic device 400 may compare the at least one image acquired by means of the camera module 422 with food images stored in the memory 440 or a server in the form of a database (DB) to acquire dietary information. The electronic device 400 may also may scan and recognize a quick response (QR) code or barcode printed on the food packaging to acquire the dietary information based on the recognized QR code or barcode.

According to an embodiment of the present disclosure, the audio module 424 may be connected to a speaker 282 for outputting audio signals (outbound or inbound ringtone for a call) transmitted/received in the electronic device 400, an audio sound included in a received message, or an audio sound during the playback of an audio file stored in the memory 440 and to at least one microphone 288 for collecting a user's voice and other audio sounds. For example, the audio module 424 may output sounds during the playback of an audio or video file or during the playing of a game. The audio module 424 may include an audio beacon. For example, the audio module 424 may receive a high frequency signal beyond human hearing range by means of the microphone and acquire dietary information based on the information included in the received signal.

The audio module 424 may analyze the food-related audio signal input by the user to acquire dietary information.

According to an embodiment of the present disclosure, the sensor module 426 may be equivalent to the sensor module 240 of FIG. 2. The sensor module 426 may include a gesture sensor, a gyro sensor, a barometric sensor, a magnetic sensor, an acceleration sensor, a grip sensor, a proximity sensor, an RGB sensor, a biometric sensor, a temperature/humidity sensor, an illuminance sensor, and a UV sensor for use in collecting health-related data of the user of the electronic device 400.

According to an embodiment of the present disclosure, the sensor module 426 may receive and/or collect the health-related information (e.g., number of steps walked, heart rate, sleep information, and depression information) of the user of the electronic device 400 and reflect the acquired health-related information in the electronic questionnaire automatically under control of the processor 450.

According to an embodiment of the present disclosure, the radio communication unit 430 (e.g., communication interface 170 of FIG. 1 and communication module 220 of FIG. 2) may implement the communication function of the electronic device 400. The radio communication unit 430 may establish a communication channel with a network for supporting at least one of a voice call, video call, and data communication functions with at least one external device. The radio communication unit 430 may include at least one of a cellular communication module for supporting at least one of 2G, 3G, and 4G cellular communication technologies, a wireless fidelity (Wi-Fi) module, and s short range wireless communication module such as near field communication (NFC) and Bluetooth′ low energy (BLE) modules. The radio communication unit 430 may include a radio frequency (RF) transmitter for up-converting and amplifying a transmission signal and an RF receiver for low noise amplifying and down-converting a received signal. The radio communication unit 430 may transfer the data received through a radio channel to the processor 450 and transmit the data output from the processor 450 to an external device through a radio channel.

According to an embodiment of the present disclosure, the radio communication unit 430 may establish a communication channel with the service provision server 500 or a cloud server to acquire dietary information of the user of the electronic device 400.

According to an embodiment of the present disclosure, the memory 440 may store programs for the operation and control of the processor 450, an operating system (OS), various applications, input/output data, and programs for controlling overall operations of the electronic device 400. The memory 440 may store user interfaces provided by the electronic device 400 and various settings necessary for executing functions of the electronic device 400.

The memory 440 includes dietary and health information DB 441, an electronic questionnaire DB 443, and a standard information DB 445.

According to an embodiment of the present disclosure, the dietary and health information DB 441 may be updated with the dietary information recorded in association with the foods consumed by the user and the health-related information (e.g., number of steps walked, heart rate, and blood pressure) input through the display 410 and the input unit 420.

For example, the dietary and health information DB 441 may store a user's favorite food group items and per-food group intake frequencies (e.g., number of intakes per day or week) and per-food group intake amounts (e.g., a cup, a dish, a spoon, number of liters or grams) and user's health information such as number of steps walked, heart rate, blood pressure, and blood sugar level.

According to an embodiment of the present disclosure, the electronic questionnaire DB 443 may organize the electronic questionnaires related to a user's food consumption habit and health condition information by type based on the user's dietary record and health condition information provided by the dietary and health information DB 441 and update the organized electronic questionnaires with at least one electronic questionnaire designed by a user.

For example, the electronic questionnaire DB 443 may store the analysis result on the questions and answers related to fat intake, dietary fiber intake, salt intake, snack and alcohol intake, life habits, and other items (correction and addition of questions and answers).

According to an embodiment of the present disclosure, the standard information DB 445 may be updated with the health condition information (such as average calorie intake amount, recommended intake amount, normal blood pressure, and blood sugar level) and food consumption habit advice acquired from the service provision server 500 (e.g., predetermined nutrition research center server and predetermined hospital server).

According to an embodiment of the present disclosure, the processor 450 (e.g., processor 120 of FIG. 1 and processor 210 of FIG. 2) may control overall operations of the electronic device 400 and signal flows among internal components and process data. For example, the processor 450 may include a central processing unit (CPU), an AP, and a CP. The processor 450 may be a single core processor or a multi-core processor or include multiple processors.

According to an embodiment of the present disclosure, the processor 450 may control the operations of and the signal flows among the components of the electronic device 400 including the display 410, the input unit 420, the camera module 422, the audio module 424, the sensor module 426, the radio communication module 430, and the memory 440. The processor 450 may organize the user's dietary record data and health condition data input by means of at least one of the display 410, the input unit 420, the camera module 422, the audio module 424, the sensor module 426, and the radio communication unit 430 into a database and may generate at least one electronic questionnaire for medical examination and management and organize the electronic questionnaire into a database to provide a customized food consumption habit advice and health care service by comparing the dietary record and information acquired through the electronic questionnaire with the standard information.

According to an embodiment of the present disclosure, the processor 450 may control the display 410 to display at least one electronic questionnaire selected automatically or in response to a user input made for selecting the at least one electronic questionnaire, analyze at least one health-related information input through at least one of the display 410 and the input unit 420 and/or acquired by means of at least one of the camera module 422, the audio module 424, and the sensor module 426, reflect the health-related information analysis result in the selected electronic questionnaire, and control the display 410 to display the electronic questionnaire to which the health-related information analysis result is reflected.

According to an embodiment of the present disclosure, the electronic device 400 may be modified according to digital device convergence. For example, the electronic device 400 may further include various sensors for detecting a change in posture and other components for locating the electronic device 400, such as a GPS module. The electronic device 400 may include at least one other component substituting for at least one of the aforementioned components, depending on its purpose.

According to an embodiment of the present disclosure, examples of the service provision server 500 may include a predetermined nutrition research center server and a predetermined hospital server. The service provision server 500 may provide the electronic device 400 with statistical standard information on the health condition information (such as the per-age, per-period, and per-season calorie intakes, recommended intake amounts, number of steps walked, heat rate, normal blood pressure range, and blood sugar level) and food consumption habit advice information. The service provision server 500 may also collect per-user dietary information and health condition information from the electronic device 400 and process the collected information to acquire statistical standard data to be provided to the electronic device 400.

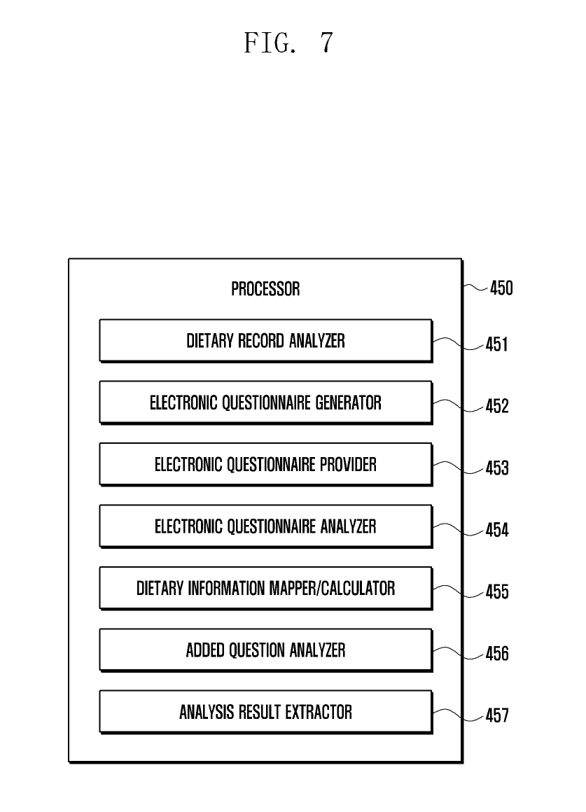

FIG. 7 is a block diagram illustrating a configuration of the processor of FIG. 4.

Referring to FIG. 7, the processor 450 includes a dietary record analyzer 451, an electronic questionnaire generator 452, an electronic questionnaire provider 453, an electronic questionnaire analyzer 454, a dietary information mapper/calculator 455, an added question analyzer 456, and an analysis result extractor 457.

According to an embodiment of the present disclosure, the dietary record analyzer 451 may analyze the dietary information related to the foods consumed by the user and the user's health condition information (e.g., number of steps walked, heart rate, and blood pressure) input through at least one of the display 410, the input unit 420, the camera module 422, the audio module 424, the sensor module 426, and the radio communication unit 430 to organize the analysis result in the dietary and health information DB 441.

According to an embodiment of the present disclosure, the electronic questionnaire generator 452 may generate various questionnaires related to per-user food consumption habit and health condition information based on the per-user dietary record data analyzed by the dietary record analyzer 451 or in response to a request of a predetermined user such as a programmer and organize the generated electronic questionnaires in the electronic questionnaire DB 443.

According to an embodiment of the present disclosure, if a user selects a certain electronic questionnaire by means of the display 410 or the input unit 420, the electronic questionnaire provider 453 may retrieve the selected electronic questionnaire from the electronic questionnaire DB 443 to display the retrieved electronic questionnaire by means of the display 410.

According to an embodiment of the present disclosure, the electronic questionnaire analyzer 454 may analyze the dietary record data acquired through at least one of the display 410, the input unit 420, the camera module 422, the audio module 424, the sensor module 426, and the radio communication unit 430 or the answers to the questions selected, corrected or added to the electronic questionnaire. The electronic questionnaire analyzer 454 may perform the analysis on the corrected and added content of the electronic questionnaire through a combination of specific words or on the answers to the questions by adding the questions stored in the memory 440 to the electronic questionnaire.

According to an embodiment of the present disclosure, the dietary information mapper/calculator 455 may categorize the food items input by the user through at least one of the display 410 and the input unit 420 and acquired through at least one of the camera module 422, the audio module 424, the sensor module 426, and the radio communication module 430 into food categories referring to dietary record data of the user analyzed by the dietary record analyzer 451 and calculate food intake frequency and intake amount per food category during a predetermined period. That is, the dietary information mapper/calculator 455 may map the categories (e.g., food categories) of the foods consumed by the user to items required for dietary record analysis to calculate intake frequency and intake amount per food category. For example, if it is recorded that the user has eaten a piece of grilled mackerel and a piece of braised hairtail for lunch on Monday and Wednesday, the mackerel and hairtail being categorized into a fish & marine category, the dietary information mapper/calculator 455 may remap the foods to a fish category and generate the information indicating two intakes of a piece of fish a week.

The dietary information mapper/calculator 455 may also reflect the dietary record data analyzed by the dietary record analyzer 451 in the electronic questionnaire provided by the electronic questionnaire provider 453.

According to an embodiment of the present disclosure, the added question analyzer 456 may analyze the corrected and added part of the electronic questionnaire through a word combination with the exception of selection of the answers to the questions in the electronic questionnaire or may analyze the detection information by adding the questions stored in the memory 440 to the electronic questionnaire.

According to an embodiment of the present disclosure, the analysis result extractor 457 may compare and analyze the information stored in the dietary and health information DB 441, the electronic questionnaire DB 443, and the standard information DB 445 to provide the health condition information such as a user's average calorie intake amount, recommended intake amount, normal blood pressure, number of steps walked, heart rate, and blood sugar level along with the food consumption habit advice information.

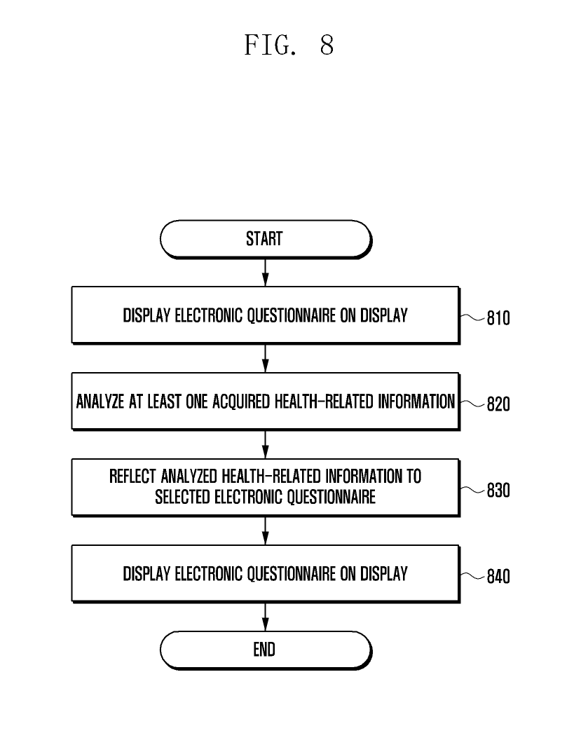

FIG. 8 is a flowchart illustrating a health information provision method, according to an embodiment of the present disclosure.

Referring to the flowchart of FIG. 8, at step 810, the processor 450 controls the display 410 to display at least one electronic questionnaire selected automatically or in response to a user input made for selecting the at least one electronic questionnaire.

At step 820, the processor 450 analyzes at least one item of health-related information input by the user through the display 410 and the input unit 420 and acquired by means of the camera module 422, the audio module 424, the sensor module 426, and the radio communication unit 430.

At step 830, the processor 450 reflects the health-related information analysis result generated at step 820 in the at least one electronic questionnaire.

At step 840, the processor 450 controls the display 410 to display the at least one electronic questionnaire to which the health-related information analysis result is applied.

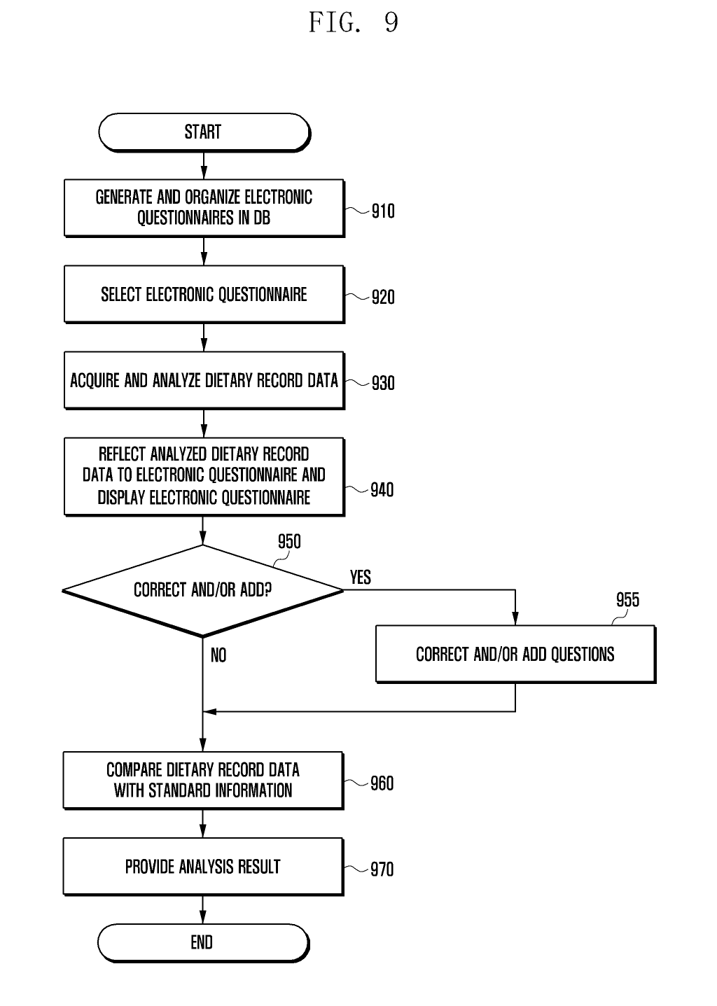

FIG. 9 is a flowchart illustrating a health care service provision method, according to an embodiment of the present disclosure.

Referring to FIG. 9, at step 910, the processor 450 generates and categorizes various questionnaires concerning a user's food consumption habit and health condition information input by a predetermined user such as a programmer and organizes the categorized electronic questionnaires in the electronic questionnaire DB 443. For example, the processor 450 categorizes various questionnaires concerning a user's food consumption habit and health condition information provided by the dietary and health information DB 441 and organizes the categorized electronic questionnaires in the form of a database at step 910.

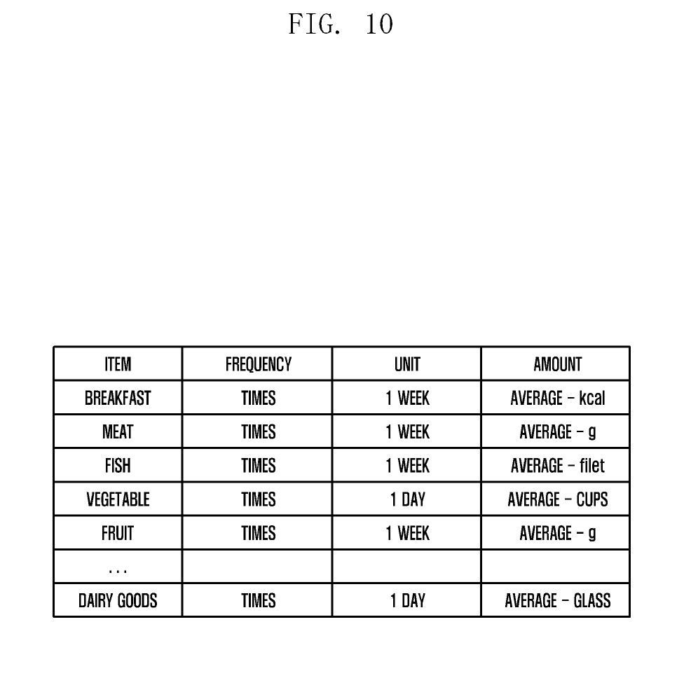

At step 920, if the user selects a certain electronic questionnaire by means of the display 410, the processor 450 may retrieve the electronic questionnaire from the electronic questionnaire DB 443 and control the display 410 to display the electronic questionnaire as shown in FIG. 6. The processor 450 may also receive the answers to the questions of the electronic questionnaire through the display 410. For example, if the answers to the questions of the electronic questionnaire as shown in FIG. 6 are input, the processor 450 may summarize the answers as shown in FIG. 10.

FIG. 10 is a diagram illustrating a table summarizing answers to questions of an electronic questionnaire, according to an embodiment of the present disclosure.

Although the embodiment of FIG. 10 is directed to a table summarizing the information on the per-category food intake frequencies, unit, and amount, it may also be possible to summarize the answers to the questions related to the health condition information such as the number of steps walked, heart rate, blood pressure, and blood sugar level.

At step 930, the processor 450 acquires dietary information related to the foods consumed by the user and health condition information of the user through at least one of the display unit 410, the input unit 420, the camera module 422, the audio module 424, the sensor module 426, and the radio communication unit 430, and analyzes the dietary information and health condition information.

At step 940, the processor 450 reflects the dietary record data as the analysis result acquired at step 930 in the electronic questionnaire selected at step 920 and controls the display 410 to display the electronic questionnaire to which the dietary record data is reflected.

At step 950, the processor 450 determines whether the user has requested any correction and/or addition of questions in the electronic questionnaire, in addition to the answers to the questions of the electronic questionnaire.

If it is determined at step 950 that the user has not requested any correction and/or addition of questions in the electronic questionnaire, at step 960 the processor 450 compares the dietary record data reflected to the electronic questionnaire at step 940 with the standard information stored in the standard information DB 445.

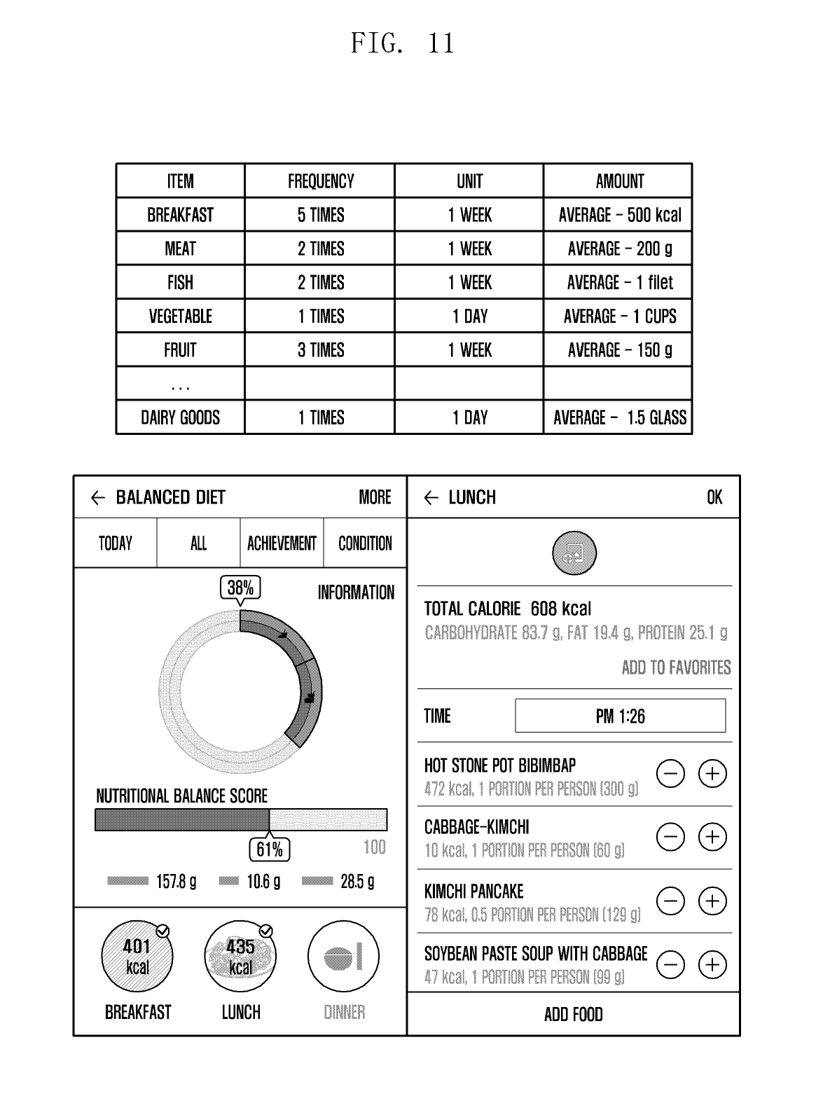

If it is determined at step 950 that the user has requested correction and/or addition of questions in the electronic questionnaire, the processor 450 corrects and/or adds questions in the electronic questionnaire at step 955 and then at step 960 compares the dietary record data acquired through the electronic questionnaire having the corrected and/or added questions with the standard information stored in the standard information DB 445. For example, if the user requests correction and/or addition of questions along with the answers to the questions of the electronic questionnaire as shown in FIG. 6, the processor 450 may generate a questionnaire report as shown in FIG. 11.

FIG. 11 is a diagram illustrating a questionnaire report generated based on the answers to the questions of the electronic questionnaire, according to an embodiment of the present disclosure.

Although the embodiment of FIG. 11 is directed to a questionnaire report with the information on the per-food category intake frequencies, unit, amount, balanced diet, and calories per meal that is generated based on the answers to the questions in the electronic questionnaire, it may also be possible to generate a health condition report with the number of steps walked, heart rate, blood pressure, and blood sugar level of the user.

At step 970, the processor 450 controls the display 410 to display the analysis report including the health condition information (such as user-customized recommended intake amount, unhealthy foods, normal blood pressure, the number of steps walked, heart rate, and blood pressure) and the recommended food consumption habit information.

According to an embodiment of the present disclosure, the analysis result may be generated by comparing the standard information stored in the electronic device 400 and the information acquired based on the answers to the questions of the electronic questionnaire that reflects the dietary record data or the user's correction and addition of questions.

The analysis result may be provided in such a way that the electronic device 400 transmits the electronic questionnaire that reflects the dietary record data or the user's correction and addition of questions to the server 500 and displays the analysis result generated and transmitted by the server 500.

As described above, the health information provision method and apparatus of the present disclosure is advantageous in terms of providing a user with customized health information by reflecting in a questionnaire at least one of health-related information items (e.g., consumed food, number of steps walked, and heart rate) collected by at least one of a display, an input unit, a camera module, an audio module, a sensor module, and a radio communication unit.

The health information provision method and apparatus of the present disclosure is advantageous in terms of improving utilization of consumed food information and user satisfaction of the health care service by making it possible for the user of the electronic device to correct parts of an electronic questionnaire and add to the questionnaire a new information item not previously recorded along with a corresponding question and answer. As a consequence, the health information provision method and apparatus of the present disclosure correctly checks for food consumption habit change by age, by season, and by a predetermined time period.

While the present disclosure has been shown and described with reference to certain embodiments thereof, it will be apparent to those skilled in the art that the present disclosure is not limited to these embodiments, and various changes in form and details may be made therein without departing from the spirit and scope of the present disclosure as defined by the appended claims and their equivalents.

What is claimed is:

1. An electronic device, comprising:
a display;
a camera module;
an audio module;
a sensor module;
a radio communication unit;
a processor which is electrically connected to the display, the camera module, the audio module, the sensor module, and the radio communication unit; and
a memory which is electrically connected to the processor, wherein
the memory stores instructions, which when executed by the processor;
display on the display at least one electronic questionnaire selected automatically or in response to a user input,
analyze at least one health-related information input by a user through the display or acquired by at least one of the camera module, the audio module, the sensor module, and the radio communication unit,
reflect the health-related information analysis result in the at least one selected electronic questionnaire, and
display on the display the at least one electronic questionnaire in which the at least one health-related information is reflected.

2. The electronic device of claim 1, wherein the processor is configured to compare information acquired through content of the at least one electronic questionnaire, in which the at least one health-related information is reflected, with standard information and provide the user with a customized analysis result.

3. The electronic device of claim 1, wherein the processor is configured to control the radio communication unit to transmit the at least one electronic questionnaire, in which the at least one health-related information is reflected, to a service provision server and receive an analysis result generated based on the at least one electronic questionnaire.

4. The electronic device of claim 1, wherein the at least one electronic questionnaire is configured for the user to request at least one of correcting a content item of the at least one electronic questionnaire and adding an additional content item to the at least one electronic questionnaire.

5. The electronic device of claim 1, further comprising an input unit, wherein the memory stores a dietary and health information database which organizes content of the at least one electronic questionnaire or the user's health-related information acquired through at least one of the display, the input unit, the camera module, the audio module, the sensor module, and the radio communication unit.

6. The electronic device of claim 1, wherein the memory stores an electronic questionnaire database which organizes the at least one electronic questionnaire related to a food consumption habit and a health condition information of the user by type.

7. The electronic device of claim 1, wherein the processor is configured to control the radio communication unit to receive at least one of standard information of the at least one electronic questionnaire, health-related information, and advice information from a service provision server.

8. The electronic device of claim 1, wherein the memory stores a standard information database which organizes at least one of standard information of the at least one electronic questionnaire, health-related information, and advice information.

9. The electronic device of claim 1, wherein the processor is configured to generate the at least one electronic questionnaire related to at least one of a food consumption habit and a health condition information of the user by type.

10. The electronic device of claim 1, wherein the processor is configured to display the at least one electronic questionnaire on the display when the user selects the at least one electronic questionnaire on the display.

11. The electronic device of claim 5, wherein the processor is configured to analyze content corrected in or added to the at least one electronic questionnaire through the display or the input unit.

12. A health information provision method of an electronic device, the method comprising:
displaying at least one electronic questionnaire selected automatically or in response to a user input;
analyzing at least one health-related information input by a user through a display or acquired by at least one of a camera module, an audio module, a sensor module, and a radio communication unit;
reflecting the health-related information analysis result in the selected electronic questionnaire; and
displaying on the display the at least one electronic questionnaire in which the at least one health-related information is reflected.

13. The method of claim 12, further comprising one of generating the at least one electronic questionnaire and receiving the at least one electronic questionnaire from a service provision server by the radio communication unit.

14. The method of claim 12, further comprising:
comparing information acquired through content of the at least one electronic questionnaire in which the at least one health-related information is reflected with standard information; and
providing the user with a customized analysis result.

15. The method of claim 12, further comprising:
transmitting the at least one electronic questionnaire in which the at least one health-related information is reflected to a service provision server by the radio communication unit; and
receiving an analysis result generated based on the at least one electronic questionnaire by the radio communication unit.

16. The method of claim 12, further comprising:
determining whether a request for correcting or adding content of the at least one electronic questionnaire is input;
comparing, if a request for correcting or adding content of the at least one electronic questionnaire is input, information acquired through the content of the at least one electronic questionnaire after reflecting the correcting or adding of content with standard information; and
displaying on the display an analysis result based on the comparison.

17. The method of claim 12, further comprising:
determining whether a request for correcting or adding content of the at least one electronic questionnaire is input;
comparing, if a request for correcting or adding content of the at least one electronic questionnaire is not input, information acquired through the content of the electronic questionnaire with standard information; and
displaying on the display an analysis result based on the comparison.

18. The method of claim 14, wherein the standard information is stored in a standard information database of the electronic device.

19. The method of claim 14, wherein the standard information is provided by a service provision server.

20. A non-transitory computer-readable storage medium which stores a program for controlling functions of an electronic device, the program comprising instructions, which when executed by a processor:
display on a display of the electronic device at least one electronic questionnaire selected automatically or in response to a user input;
analyze at least one health-related information input by a user through the display or acquired by at least one of a camera module, an audio module, a sensor module, and a radio communication unit;
reflect the health-related information analysis result in the at least one selected electronic questionnaire; and
display on the display the at least one selected electronic questionnaire in which the at least one health-related information is reflected.
